(19) United States
(12) Patent Application Publication
(10) Pub. No.: US 2011/0044812 A1
(43) Pub. Date: Feb. 24, 2011

(54) AIRFOIL WITH FLOW DEFLECTOR

(76) Inventor: Xiao Ming, Nanjing (CN)

Correspondence Address: NIXON & VANDERHYE, PC, 901 NORTH GLEBE ROAD, 11TH FLOOR, ARLINGTON, VA, 22203, US

(21) Appl. No.: 12/736,485

(22) PCT Filed: May 6, 2009
(86) PCT No.: PCT/GB2009/050471

§ 371 Date: Oct. 13, 2010

(30) Foreign Application Priority Data
May 14, 2008 (GB) 0808688.6

(51) Int. Cl. F15D 1/12

(52) U.S. Cl. 416/1; 416/223 R

(57) ABSTRACT

An airfoil comprising a high pressure surface; a low pressure surface; a leading edge where the high and low pressure surfaces meet at the front of the airfoil; and a trailing edge where the high and low pressure surfaces meet at the back of the airfoil. A porous flow deflector extends from the low pressure surface. The porous flow deflector is attached to the low pressure surface at a position which is closer in a chord-wise sense to the leading edge than to the trailing edge. That is, the percentage chord distance between the leading edge and the position where the flow deflector is attached is less than 50%. The porous flow deflector comprises a plurality of flow deflection members each spaced progressively further from the low pressure surface in a direction away from the low pressure surface, and each flow deflection member is angled down to the rear relative to a local tangent of the low pressure surface. The porous flow deflector deflects air towards the low pressure surface as it passes through the porous flow deflector.

### FIELD OF THE INVENTION

The present invention relates to an airfoil with a flow deflector, and a method of operating such an airfoil. The airfoil may comprise an aircraft wing or control surface, or another airfoil such as a turbine blade.

### BACKGROUND OF THE INVENTION

Boundary layer separation is a phenomenon shown in FIG. 1 in which the boundary layer peels 1 away from the solid surface 2 of an aircraft wing or other airfoil as the result of an adverse pressure gradient opposing the flow along it. When the boundary layer 1 separates, the lift drops, the drag increases dramatically, and the aircraft will stall.

Boundary layer separation control is therefore very important for aircraft. If the separation at high angles of attack could be controlled, then the high lift performance of the aircraft would be improved.

The already well established slat and flap high-lift systems have approached very high maturity levels, making it difficult to further improve their performance. Vortex generators are conventionally used to prevent local flow separation, but are inefficient at high angles of attack.

### SUMMARY OF THE INVENTION

A first aspect of the invention provides an airfoil comprising a high pressure surface; a low pressure surface; a leading edge where the high and low pressure surfaces meet at the front of the airfoil; a trailing edge where the high and low pressure surfaces meet at the back of the airfoil; and a porous flow deflector extending from the low pressure surface, wherein the porous flow deflector is attached to the low pressure surface at a position which is closer in a chord-wise sense to the leading edge than to the trailing edge (that is, the percentage chord distance between the leading edge and the position where the flow deflector is attached is less than 50%), wherein the porous flow deflector comprises a plurality of flow deflection members each spaced progressively further from the low pressure surface in a direction away from the low pressure surface, and wherein each flow deflection member is angled down to the rear relative to a local tangent of the low pressure surface.

A second aspect of the invention provides a method of operating an airfoil, the airfoil comprising a high pressure surface; a low pressure surface; a leading edge where the high and low pressure surfaces meet at the front of the airfoil; a trailing edge where the high and low pressure surfaces meet at the back of the airfoil; and a porous flow deflector extending from the low pressure surface, wherein the porous flow deflector is attached to the low pressure surface at a position which is closer in a chord-wise sense to the leading edge than to the trailing edge, the method comprising deflecting air towards the low pressure surface as it passes through the porous flow deflector.

By deflecting air towards the low pressure surface, the flow deflector has the effect of resisting separation of a boundary layer next to the low pressure surface downstream of the flow deflector.

Various preferred features of the invention are set out in the dependent claims.

### BRIEF DESCRIPTION OF THE DRAWINGS

Embodiments of the invention will now be described with reference to the accompanying drawings, in which:

FIG. 1 is a schematic diagram showing boundary layer separation;

FIG. 2 is a sectional side view of an aircraft wing with a flow deflector according to an embodiment of the present invention;

FIG. 3 is an enlarged view of the upper forward portion of the wing;

FIG. 4 is a perspective view of the flow deflector; and

FIG. 5 is an enlarged view of the upper forward portion of the wing; showing various parameters associated with the flow deflector.

### DETAILED DESCRIPTION OF EMBODIMENT(S)

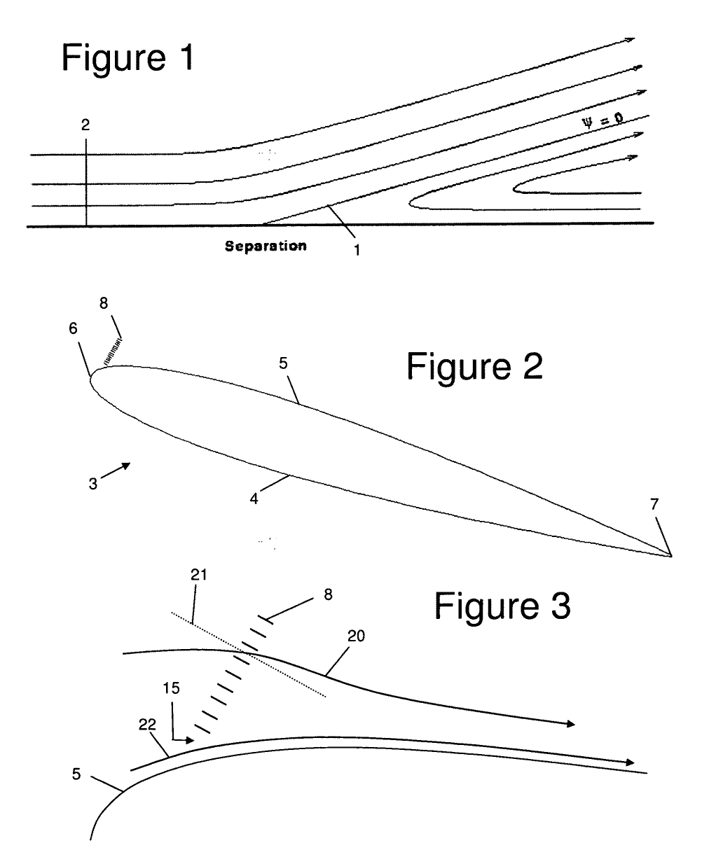

An aircraft wing 3 shown in FIG. 2 comprises a lower (high pressure) surface 4; an upper (low pressure) surface 5; a leading edge 6 where the surfaces 4,5 meet at the front of the wing; and a trailing edge 7 where the surfaces 4,5 meet at the back of the wing. A porous flow deflector 8 extends from the upper surface 5 at a position proximate the leading edge 6. The flow deflector 8 runs along the full span of the wing and is mounted to the fixed parts of the leading edge.

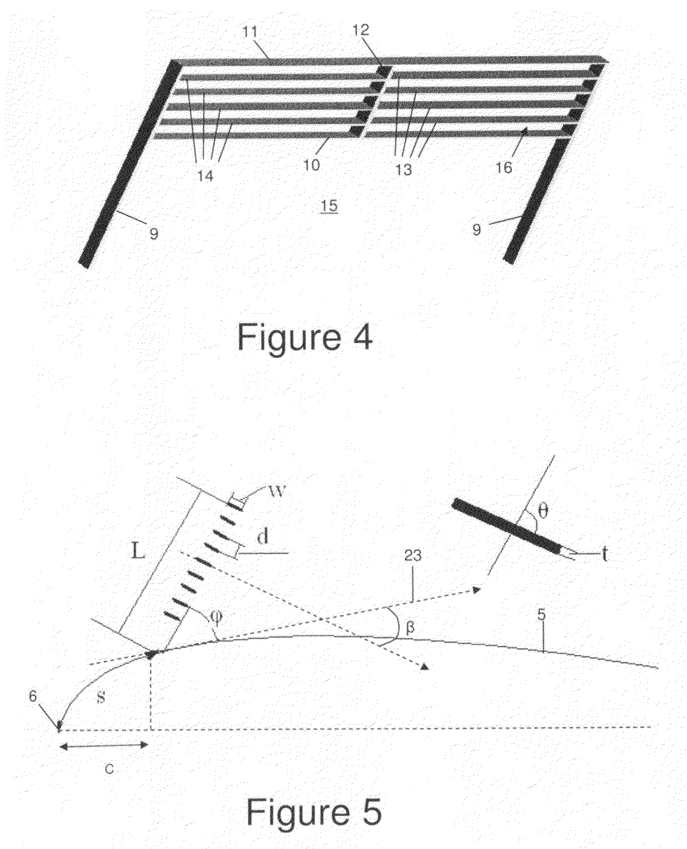

The porous flow deflector is shown in detail in FIG. 4. It comprises a pair of support legs 9 attached to the upper surface 5, bottom and top strips 10, 11 extending between the support legs 9, and a central support member 12. Right-hand strips 13 extend between the right-hand support leg 9 and the central support member 12; and left-hand strips 14 extend between the left-hand support leg 9 and the central support member 12.

The bottom strip 10 is separated from the upper surface 5 by a boundary layer slot 15, and each of the strips 10,11,13,14 is spaced apart from an adjacent strip by a respective flow deflection slot 16, each slot 16 being spaced from the upper surface 5 by a different distance. Note that the flow detector 8 shown in FIGS. 2 and 3 has nine layers of strips in total, but the flow deflector shown in FIG. 4 has only six. As can be seen in FIG. 4, the slots are elongate, and the length of the slots is oriented in a substantially span-wise direction. The length of the boundary layer slot 15 is greater than the length of each flow deflection slot 16. Also the bottom strip 10 is spaced from the upper surface 5 by a distance greater than space between adjacent strips (in other words the height of the boundary layer slot 15 is greater than the height of the flow deflection slots 16).

The flow deflector 8 is manufactured from a single piece, and made porous by removing material from the piece to form the slots 15, 16, for instance by spark erosion.

As shown in FIG. 3, the strips of the flow deflector 8 are angled down to the rear relative to the high energy air flow 20 immediately upstream of the flow deflector so that they deflect the air flow 20 towards the upper surface 5 and towards a line 21 normal to the flow deflector 8 as it passes through the flow deflector, whilst permitting a boundary layer 22 of air which builds from the front of the airfoil to flow substantially unimpeded next to the upper surface 5 and through the boundary layer slot 15.

This energizes the boundary layer 22 to resist the adverse pressure gradients that make the boundary layer separate from the surface. For this reason the flow deflector is deployed near the leading edge. The wake of the flow deflector 8 also has positive effects that enhance the turbulence downstream through an interaction between the wake flow and the boundary layer flow. This enhanced turbulence also helps resist boundary layer separation.

The geometry of the flow deflector 8 is shown in FIG. 5. L is the total length of the deflector measured from the upper surface 5 of the wing, φ is the angle of the deflector 8 relative to the local tangent 23 of the upper surface 5 (that is, the local tangent 23 at the point where the flow deflector meets the upper surface 5), w is the width of the strips 10,11,13,14, t is the thickness of each strip, d is the distance between the centres of two adjacent strips, θ is the angle of each strip (and the associated flow deflection channels defined by the slots 16 between the strips) relative to the deflector 8, s is the distance (as measured along the upper surface 5) between the leading edge 6 and the points where the supports 9 of the flow deflector are attached, β is the angle of each flow deflection strip relative to the local tangent of the upper surface 5 (note that β=θ−φ+90°), and c is the percentage chord distance between the leading edge 6 and the points where the supports 9 of the flow deflector are attached, as a proportion of the total chord of the wing. Note that these parameters are defined for the wing in its cruise configuration with the slats and flaps retracted.

For a wing with a 300 mm chord length, these parameters typically fall within the following ranges: 20 mm>L>10 mm, 90°>φ>60°, 3 mm>w>0.5 mm, 0.3 mm>t>0.1 mm, 3 mm>d>1 mm, 120°>θ>80°, 50 mm>s>5 mm, 20%>c>1%.

Preferably each flow deflection strip (and accordingly each flow deflection channel 16) is angled down to the rear relative to the local tangent of the low pressure upper surface 5. In other words θ<β<90°. Thus in the special case where the flow deflector extends at right angles to the local tangent of the upper surface (that is, φ=90°) then the flow deflection strips are preferably angled down to the rear relative to the flow deflector (that is, θ must be greater than 90° and less than 180°) in the manner of a louvre blind.

For a wing with a 300 mm chord length, preferred values for these parameters are: L=15 mm, φ=70°, w=1 mm, t=0.1 mm, d=2 mm, θ=110°, s=10 mm, c=2%.

The legs 9 of the flow deflector may be attached to the wing at a fixed angle φ. In this case the legs are inserted into drilled holes in the wing, the drilled holes having axes at the desired angle.

Alternatively the legs 9 may be pivotally attached to the wing. For example the legs 9 may be joined to a pivot that is mounted on the wing, with chord-wise slots in the wing enabling the legs 9 to change angle. It has been found that the flow deflector 8 generates lift, so it may be possible for this lift to deploy the flow deflector passively from a retracted position where it lies parallel to the upper surface 5 (that is, φ=0°) to a raised position such as φ=70°. Also the angle φ may be controllable for instance by means of a rotary electric actuator which drives the pivot to which the legs 9 are attached.

If one flow deflector 8 is not enough, then one or more additional flow deflectors may be arranged to form a cascade of flow deflectors spaced apart from each other in a chord-wise sense. Each of them will deflect the air by a limited angle until the flow stream attaches to the surface completely. The deflection angle φ of each deflector in the cascade may be independently controllable according to the flow condition.

Although the invention has been described above with reference to one or more preferred embodiments, it will be appreciated that various changes or modifications may be made without departing from the scope of the invention as defined in the appended claims.

1. An airfoil comprising a high pressure surface; a low pressure surface; a leading edge where the high and low pressure surfaces meet at the front of the airfoil; a trailing edge where the high and low pressure surfaces meet at the back of the airfoil; and a porous flow deflector extending from the low pressure surface, wherein the porous flow deflector is attached to the low pressure surface at a position which is closer in a chord-wise sense to the leading edge than to the trailing edge, wherein the porous flow deflector comprises a plurality of flow deflection members each spaced progressively further from the low pressure surface in a direction away from the low pressure surface, and wherein each flow deflection member is angled down to the rear relative to a local tangent of the low pressure surface.

2. The airfoil of claim 1 wherein the porous flow deflector comprises a pair of legs attached to the low pressure surface, a first flow deflection member extending between the legs and separated from the low pressure surface by a boundary layer gap, and one or more additional flow deflection members each spaced apart from an adjacent flow deflection member by a respective gap.

3. The airfoil of claim 1 wherein the flow deflector is angled to the rear relative to a local tangent of the low pressure surface.

4. The airfoil of claim 3 wherein the angle between the flow deflector and the local tangent of the low pressure surface is greater than 60°.

5. (canceled)

6. The airfoil of claim 1 wherein the flow deflector has a plurality of flow deflection channels which extend at an angle θ relative to the flow deflector, and wherein θ is greater or less than 90°.

7. The airfoil of claim 1 wherein the flow deflector is pivotally attached to the low pressure surface.

8. (canceled)

9. The airfoil of claim 1 wherein the flow deflection member nearest the low pressure surface is separated therefrom by a boundary layer gap such that a boundary layer of air which builds from the front of the airfoil is permitted to flow substantially unimpeded next to the low pressure surface and through the boundary layer gap.

10. The airfoil of claim 9 wherein the boundary layer gap is an elongate slot, the length of the slot being oriented in a substantially span-wise direction.

11. The airfoil of claim 10 wherein the flow deflector comprises one or more flow deflection channels each positioned between a pair of adjacent flow deflection members, and wherein the span-wise length of the boundary layer gap is greater than a span-wise length of each flow deflection channel.

12. (canceled)

13. (canceled)

14. A method of operating an airfoil, the airfoil comprising a high pressure surface; a low pressure surface; a leading edge where the high and low pressure surfaces meet at the front of the airfoil; a trailing edge where the high and low pressure surfaces meet at the back of the airfoil; and a porous flow deflector extending from the low pressure surface, wherein the porous flow deflector is attached to the low pressure surface at a position which is closer in a chord-wise sense to the leading edge than to the trailing edge, the method comprising deflecting air towards the low pressure surface as it passes through the porous flow deflector, thereby energizing a boundary layer next to the low pressure surface.

15. The method of claim 14, further comprising permitting the boundary layer of air which builds from the front of the airfoil to flow substantially unimpeded next to the low pressure surface and through the porous flow deflector.

16. The method of claim 14 further comprising enhancing turbulence downstream of the porous flow deflector through an interaction between a wake flow and a boundary layer flow.

17. The method of claim 14 wherein the porous flow deflector comprises a plurality of flow deflection members each spaced progressively further from the low pressure surface in a direction away from the low pressure surface, and each flow deflection member is angled down to the rear relative to a local tangent of the low pressure surface, and wherein the method further comprises angling the flow deflection members down to the rear relative to the air flow immediately upstream of the flow deflector.

18. (canceled)

19. The airfoil of claim 1 wherein each flow deflection member has a width (w) which is less than 1% of the chord length of the airfoil.

20. The airfoil of claim 1 wherein the porous flow deflector comprises a first flow deflection member which is separated from the low pressure surface by a boundary layer gap and two or more additional flow deflection members each spaced apart from an adjacent flow deflection member by a respective flow deflection channel, and wherein the height of the boundary layer gap is greater than the heights of each of the flow deflection channels.
